(19) United States
(12) Patent Application Publication
(10) Pub. No.: US 2022/0186387 A1
(43) Pub. Date: Jun. 16, 2022

(54) REACTOR FOR GAS PRODUCTION

(71) Applicant: H2 SOLUTION S.R.O, Brno, Zebetin (CZ)

(72) Inventor: Qusay Al Ansari, Belgrade (RS)

(73) Assignee: H2 SOLUTION S.R.O, Brno, Zebetin (CZ)

(21) Appl. No.: 17/594,907

(22) PCT Filed: Dec. 2, 2019
(86) PCT No.: PCT/CZ2019/050058

§ 371 Date: Nov. 2, 2021

(30) Foreign Application Priority Data
May 3, 2019 (CZ) PV2019-276

(51) Int. Cl. C25B 9/77; C25B 15/08; C25B 1/04; C25B 9/60

(52) U.S. Cl. CPC C25B 9/77; C25B 9/60; C25B 1/04; C25B 15/08

(57) ABSTRACT

The invention relates to a reactor which comprises a plurality of mutually parallel plates arranged spaced apart from each other, and adapted to be attached to a current source such that at least one of the plates is a cathode plate, at least one of the plates is an anode plate and at least one of the plates is a neutral plate and arranged between the cathode plate and the anode plate, and a plurality of frames, each of the frames of the plurality of frames being arranged for circumferentially enclosing a cavity adjacent to at least one the plates, and a conduit for supplying water and electrolyte into said cavities and a conduit for leading the liquid enriched with the produced gas formed in said cavities from the reactor, wherein the reactor further comprises at least one permanent magnet or a plurality of permanent magnets attached to the anode plate and to the neutral plates spaced apart from each other at that side of the anode plate which faces the cathode plate, the north sides of the permanent magnets facing the cathode plate.

### FIELD OF THE ART

The invention relates to a reactor for gas production by means of electrolysis, the reactor comprising at least one exhaust for the produced gas, and a plurality of mutually parallel plates arranged spaced apart from each other and adapted to be attached to a current source such that at least one of the plates is cathode plate, at least one of the plates is anode plate and at least one of the plates is neutral and arranged between the cathode plate and the anode plate, wherein the anode plate and the neutral plates are provided with one magnet, or a plurality of magnets, the individual plates being separated by rubber frames for maintaining the predetermined distance of the individual plates from each other and for forming water tight cavities between the plates.

### BACKGROUND ART

Reactors for the production of gases using electrolysis are known in the art. The aim of the invention is to increase the efficiency of such reactors. This is achieved by using magnetic field which, during the process of electrolysis, accelerates the electrons, thus accelerating the production of the gas without increasing the input amperage.

### SUMMARY OF THE INVENTION

The subject-matter of the invention is a reactor for gas production, which comprises a plurality of mutually parallel plates arranged spaced apart from each other, and adapted to be attached to a current source such that at least one of the plates is a cathode plate, at least one of the plates is an anode plate and at least one of the plates is a neutral plate and arranged between the cathode plate and the anode plate. The reactor further comprises a plurality of frames, each of the frames of the plurality of frames being arranged for circumferentially enclosing a cavity adjacent to at least one of the plates, and a conduit for supplying water and electrolyte into said cavities and a conduit for leading the liquid enriched with the gas formed in said cavities from the reactor. The reactor according to the invention is characterised in that it further comprises at least one permanent magnet, preferably a plurality of permanent magnets attached to the anode plate and to the neutral plates spaced apart from each other at that side of the anode plate which faces the cathode plate, the north sides of the permanent magnets facing the cathode plate. In a preferred embodiment each frame in the reactor is arranged between two plates to form a cavity enclosed by the frame and the two adjacent plates, or the reactor further comprises a plurality of membranes, wherein each frame comprises two parts, wherein each part of the frame is arranged between a plate and a membrane to form a cavity enclosed by said part of the frame, said plate, and said membrane. The magnetic field may be created by one permanent magnet, or preferably by a plurality of permanent magnets. The permanent magnets are preferably neodymium magnets, and/or have a disc shape having the diameter within the range of 7 to 13 mm, preferably 9 to 11 mm, and/or a thickness within the range of 0.4 to 1.5 mm. The plates are preferably made of stainless steel. In another preferred embodiment at least some of the plates are provided with scratches, preferably horizontal and vertical scratches. The spacing between the plates is preferably uniform and within the range of 2.3 to 2.9 mm, preferably 2.6 to 2.8 mm. In yet another embodiment the plates are arranged forming at least one set, which comprises a sequence of a cathode plate, a plurality of neutral plates, an anode plate, a plurality of neutral plates and a cathode plate. The number of neutral plates at one side of the anode plate is preferably the same as the number of the neutral plates at the other side of the anode plate, such that the anode plate is arranged in the middle of the set, wherein the preferred number of neutral plates at each side of the anode plate is 5. The reactor according to the invention preferably comprises at least two electrically insulating and water-proof end members, the plates and the frames being clamped between the end members.

### BRIEF DESCRIPTION OF THE DRAWINGS

Exemplary embodiments of the invention are shown in the attached drawings.

FIG. 1 shows the first exemplary embodiment of the invention.

FIG. 2 shows a detailed view of a part of the reactor of FIG. 1.

FIG. 3 shows the arrangement of the magnets on the plates of the first exemplary embodiment.

FIG. 4 shows a photo of a plate provided with grooves.

FIG. 5 shows the second exemplary embodiment of the invention.

FIG. 6 shows a detailed view of a part of the reactor of FIG. 5.

FIG. 7 shows the individual plates, frames and membrane of the second exemplary embodiment.

### DETAILED DESCRIPTION OF EXEMPLARY EMBODIMENTS

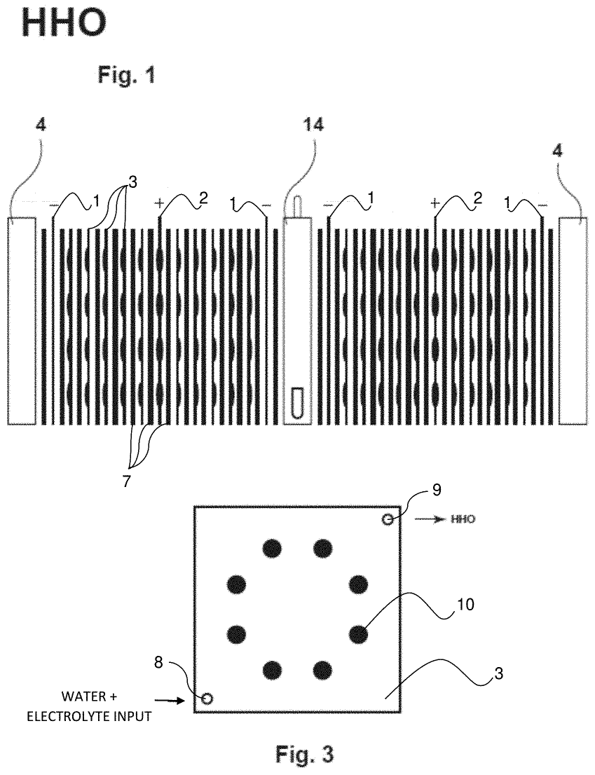

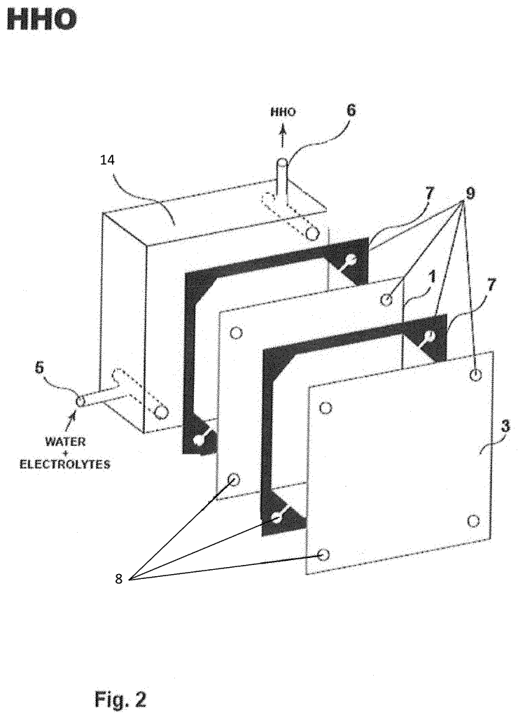

The first embodiment of the reactor shown in FIGS. 1 and 2 is adapted for production of oxyhydrogen, i.e. a mixture of hydrogen and oxygen (HHO).

Said reactor comprises mutually parallel plates 1, 2, 3, which are arranged spaced apart from each other, wherein the mutual spacing between the adjacent plates 1, 2, 3 is uniform and it is 3 mm or less, preferably less than 3 mm and more than 2.3 mm, more preferably between 2.6 and 2.8 mm, the most preferably 2.67 mm.

The plates 1, 2, 3 may be of any shape, such as square, rectangular, trapezoidal, circular, and the like, the square or rectangular shape being preferred. The plates 1, 2, 3 are made of stainless steel, such as 316L. In one embodiment, the plates 1, 2, 3 are 180 mm (height)×180 mm (width).

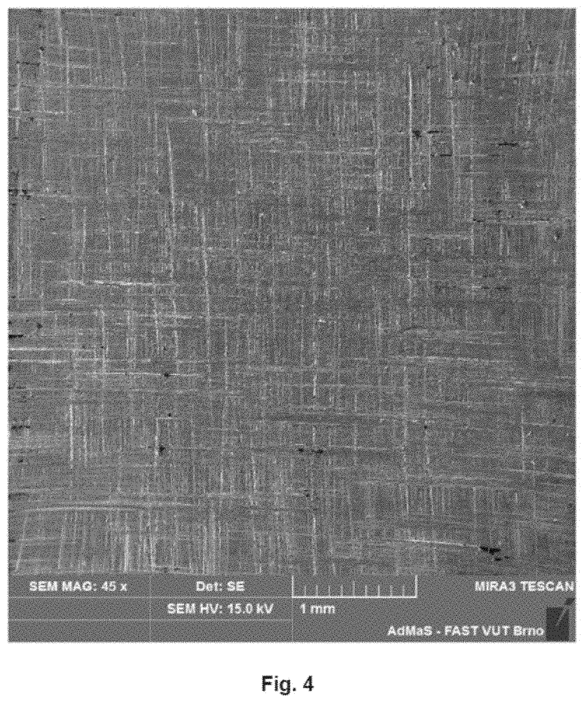

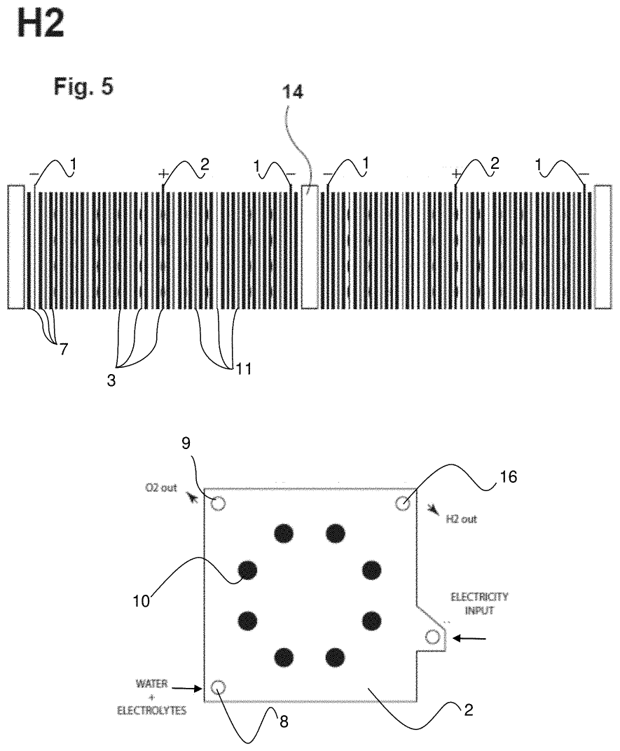

Prior to using, it is preferable to treat the plates 1, 2, 3 in a specific way. Such treatment consists in that each side of the plates 1, 2, 3 is scratched horizontally in one direction, and then vertically from bottom to the top side of the plate 1, 2, 3, again only in this one direction. The width of the scratched grooves is 10⁻³ mm to 10⁻¹ mm, preferably 10⁻³ mm to 2.10⁻² mm. The depth of the scratched grooves is 10⁻³ mm to 10⁻² mm. A photo of a scratched plate 1, 2, or 3 is shown in FIG. 4. Then the plates 1, 2, 3 are stored in alcohol, such as ethanol, for at least about 24 hours. Said treatment has positive impact on leading the gases out of the cells and also removing coat of oil from the surface.

In this particular embodiment shown in FIG. 1 and FIG. 2, there are 26 plates 1, 2, 3, which are attached to a current source such that four of the plates are cathode plates 1, two of the plates are anode plates 2 and the rest of the plates are neutral plates 3. The particular arrangement of plates 1, 2, 3 is such that there are two sets of 13 plates 1, 2, 3 arranged in the following particular order: a cathode plate 1, five neutral plates 3, an anode plate 2, five neutral plates 3 and a cathode plate 1. Thus, each of the sets comprises one anode plate 2 arranged in the middle of the set, then there is a cathode plate 1 arranged at each side of the set and five neutral plates 3 arranged always between the anode plate 2 and the cathode plate 1.

The individual plates 1, 2, 3 are mutually separated by rubber frames 7, the outer circumferential surface of which substantially corresponds to the outer circumferential surface of the plates 1, 2, 3. Each of the frames 7 keeps a pair of neighbouring plates 1, 2, 3 spaced apart providing thus mutual insulation and it encloses the space between those plates 1, 2, 3 forming a closed/leak proof cavity between the neighbouring plates 1, 2, 3.

The reactor shown in the drawings 1 and 2 further comprises end members 4 which are adapted to keep the above described sets of plates 1, 2, 3 and frames fixed in their mutual positions. The fixation may be provided by means of tensioning bars (not shown), which clamp the end members 4 keeping the plates 1, 2, 3 and frames 7 tightly pressed against each other, so that leakage of water and electrolyte from the cavities is prevented.

Between the above described sets of plates 1, 2, 3, there is a fluid leading member 14, which comprises an inlet channel 5 for supplying water and electrolyte into the reactor and an oxyhydrogen outlet channel 6 for leading the oxyhydrogen enriched fluid from the reactor.

The end members 4 as well as the fluid leading member 14 are made of a waterproof and electrically insulating material, such as poly(methyl methacrylate).

As described above, there are closed cavities, each of them being delimited by a frame 7 and two mutually neighbouring plates 1, 2, 3 in the reactor. Said cavities are in fluid communication for allowing free passage of liquids and gases. In this particular example, each of the plates 1, 2, 3, and frames 7 is provided with a first through-hole 8 for the passage of water with the electrolyte from one cavity to another. The first through-holes 8 are aligned with each other and with the outlet opening of the inlet channel 5 of the fluid leading member 14 to form a conduit for water and electrolyte from the inlet channel 5 to each of the cavity. The frames 7 have their first through-holes 8 in fluid communication with the respective cavities.

Furthermore, each of the plates 1, 2, 3, and frames 7 is provided with a second through-hole 9 for the passage of the liquid (water) enriched with oxyhydrogen from one cavity to another, or rather from the individual cavities towards the oxyhydrogen outlet channel 6. The second through-holes 9 are aligned with each other and with the inlet opening of the oxyhydrogen outlet channel 6 of the fluid leading member 14 to form a conduit for the liquid enriched with oxyhydrogen formed in the cavities and to allow its passage into the oxyhydrogen outlet channel 6. To this effect, the frames 7 have their second through-holes 9 also in fluid communication with the respective cavities.

The first through-hole 8 and the second through-hole 9 within a plate 1, 2, 3 or frame 7 are arranged in diagonally opposite corners of the plate 1, 2, 3 or frame 7. However, other mutual arrangements are also possible. Preferably the first through holes 8 are formed in the lower part of the plates 1, 2, 3, the second through holes 9 are formed in the upper part of the plates 1, 2, 3.

Each anode plate 2 is provided with a plurality of permanent magnets 10 attached thereto at that side of the anode plate 2 which faces the nearest cathode plate 1 of the particular set, the north sides of the permanent magnets 10 facing the cathode plate 1. In this particular embodiment, the anode plates 2 being in the middle of the sets of plates 1, 2, 3, the permanent magnets 10 are arranged at both sides of each anode plate 2.

Also each of the neutral plates 3 is provided with a plurality of permanent magnets 10 at that side which faces the nearest cathode plate 1 belonging to that particular set, north side of the magnets 10 facing the cathode plate 1.

The number and the size of the magnets 10 is proportional to the size of the anode plates 2 and the aim is to form an (as much as possible) uniform magnetic field throughout the whole area, an exemplary arrangement of the magnets is shown on FIG. 3. Each of the permanent magnets 10 is attached to the neutral plate 3 or the anode plate 2, not touching any other plate 1, 2, 3.

Preferably, the permanent magnets 10 are neodymium magnets, but any other type of material providing a magnetic field may be used instead.

The permanent magnets 10 may be attached to the anode plates 2 and the neutral plates 3 by means of a glue, or any other suitable means.

Of course, the above specified preferred embodiment may be altered in many ways without departing from the scope of invention. The number of the neutral plates 3 within a set may be changed, the number of the above specified sets of plates 1, 2, 3 and the size of the plates 1, 2, 3 may be adapted based on the required output of the reactor. The frames 7 have been described as rubber frames, but other materials may be used for the frames 7.

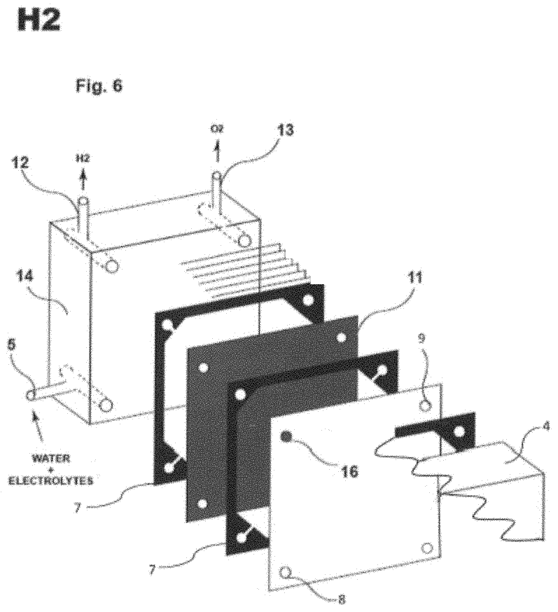

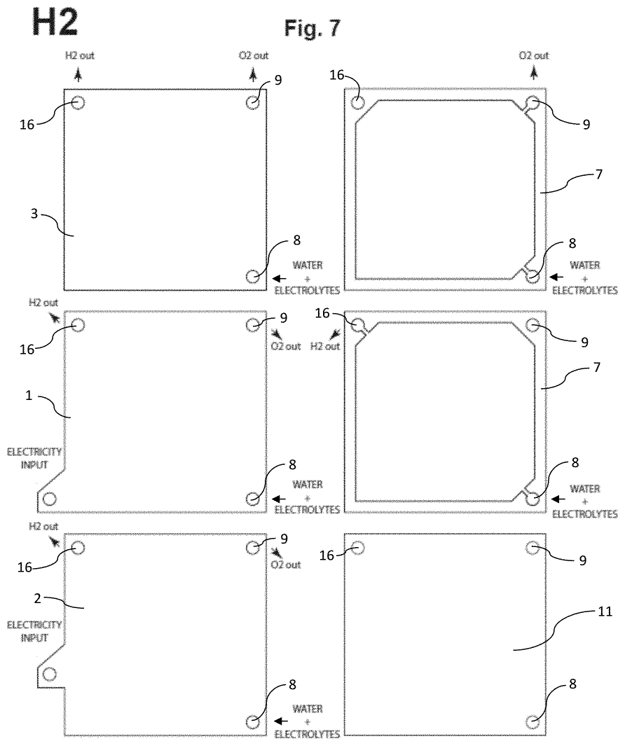

In a second exemplary embodiment, which is shown on FIGS. 5 and 6, the reactor is adapted for the production of hydrogen (H2), or in other words, for the production of two separate gases hydrogen and oxygen. In this embodiment, there are 26 plates 1, 2, 3, which are attached to a current source such that four of the plates are cathode plates 1, two of the plates are anode plates 2 and the rest of the plates are neutral plates 3. The particular arrangement of plates 1, 2, 3 is such that there are two sets of 13 plates 1, 2, 3 arranged in the following particular order: a cathode plate 1, five neutral plates 3, an anode plate 2, five neutral plates 3 and a cathode plate 1. Thus, each of the sets comprises one anode plate 2 arranged in the middle of the set, then there is a cathode plate 1 arranged at each side of the set and five neutral plates 3 arranged always between the anode plate 2 and cathode plate 1. Again, there are frames 7 for enclosing cavities between the neighbouring plates 1, 2, 3. Moreover, in order to ensure the separation of hydrogen from oxygen, there are membranes 11 between the individual plates 1, 2, 3. Each membrane 11 divides a cavity formed between a pair of neighbouring plates 1, 2, 3 in two sub-cavities, one of them extending along one of the plates 1, 2, 3, the other extending along the other of the plates 1, 2, 3 from the pair. The membranes 11 are permeable for hydrogen only. The individual plates 1, 2, 3 are mutually separated by rubber frames 7, the outer circumferential surface of which substantially corresponds to the outer circumferential surface of the plates 1, 2, 3. In this embodiment, the frames 7 are in a two part form, wherein each of the membranes 11 is held between the two parts of a frame 7. Other means of attachment of the membranes are also possible.

The sequence of the individual components of the sets is as follows: a cathode plate 1, first part of a first rubber frame 7, membrane 11, second part of the first rubber frame 7, neutral plate 3, first part of a second rubber frame 7, membrane 11, second part of the second rubber frame 7, neutral plate 3, first part of a third rubber frame 7, membrane 11, second part of the third rubber frame 7 . . . , as shown in FIG. 5.

The reactor shown in the FIGS. 5 and 6 further comprises end members 4 which are adapted to keep the above described sets of plates 1, 2, 3, frames 7 and membranes 11 fixed in their mutual positions. The fixation may be provided by means of tensioning bars (not shown), which clamp the end members 4 keeping the plates 1, 2, 3, frames 7 and membranes 11 tightly pressed against each other, so that leakage of water and electrolyte from the cavities is prevented. The end members 4 themselves are also separated from the cathode plate 1 by a rubber frame 7.

Between the above described sets of plates 1, 2, 3, there is a fluid leading member 14, which comprises an inlet channel 5 for supplying water and electrolyte into the reactor, a hydrogen outlet channel 12 for leading the liquid enriched with hydrogen from the reactor and an oxygen outlet channel 13 for leading the liquid enriched with oxygen from the reactor.

There are closed cavities, each of them being delimited by a frame 7 and a plate 1, 2, or 3 and being divided by a membrane 11 in the reactor. Said cavities are in fluid communication for allowing free passage of liquids and gases. In this particular example, each of the plates 1, 2, 3, and frames 7 (both parts) and membranes 11 is provided with a first through-hole 8 for the passage of water with the electrolyte from one cavity to another. The first through-holes 8 are aligned with each other and with the outlet opening of the inlet channel 5 of the fluid leading member 14 to form a conduit for water and electrolyte from the inlet channel 5 to each of the cavity. The frames 7 (both parts) have their first through-holes 8 in fluid communication with the respective cavities.

Furthermore, each of the plates 1, 2, 3, frames 7 and membranes 11 is provided with a second through-hole 9 for the passage of oxygen (or rather liquid enriched with oxygen), and with a third through-hole 16 for the passage of hydrogen (or rather liquid enriched with hydrogen). The second through-holes 9 are aligned with each other and with the inlet opening of the oxygen outlet channel 13 of the fluid leading member 14 to form a conduit for the liquid enriched with the oxygen formed in the cavities and to allow its passage into the outlet channel 13, and the third through-holes 16 are aligned with each other and with the inlet opening of the hydrogen outlet channel 12 of the fluid leading member 14 to form a conduit for the liquid enriched with the hydrogen formed in the cavities and to allow its passage into the outlet channel 12.

To this effect, the first parts of individual frames 7, which are arranged on that side of the membrane 11 which are closer to the anode plate 2, have their second through-hole 9 in fluid communication with the respective cavities, and the second parts of individual frames 7, which are arranged on the other side of the membrane 11, i.e. which are closer to the cathode plate 1, have their third through-hole 16 in fluid communication with the respective cavities.

In a preferred embodiment the reactor is provided with cooling means, such as a fan, for maintaining the temperature of the electrolyte inside the reactor below 35° C. Preferably, the reactor is provided with a sensing means for monitoring the temperature of the electrolyte, the sensing means being connected with a control unit for controlling the cooling means based on the information provided from the sensing means.

Each anode plate 2 is provided with a plurality of permanent magnets 10 attached thereto at that side of the anode plate 2 which faces the cathode plate 1, the north sides of the permanent magnets 10 facing the nearest cathode plate 1 of the respective set. Also each of the neutral plates 3 is provided with a plurality of permanent magnets 10 at that side which faces the nearest anode plate 2 belonging to that particular set, north side of the magnets 10 facing said cathode plate 1.

Preferably, the permanent magnets 10 are neodymium magnets, but any other type of material providing a magnetic field may be used instead. The permanent magnets 10 may be attached to the anode plates 2 and neutral plates 3 by means of a glue, or any other suitable means.

The number and the size of the magnets 10 is proportional to the size of the anode plates 2 and according to a preferred embodiment, the permanent magnets 10 have a disc shape having the diameter of 10 mm and the thickness of 1 mm and are attached to the anode plate 2 or neutral plate 3 such that their axis (or axis of the magnet force action) is perpendicular to the plate. Other types and sizes of magnets may be used instead, such as having the thickness of 0.5 mm.

A preferred number of magnets 10 may be counted according to the equation 1 as follows:

$$M n = \frac{a}{( F \times 2 ) + M d}$$

wherein
Mn is the number of magnets 10
a is the length/height of the plate 2, 3 having a square shape measured in mm,
F is the magnet field range measured in mm (the value may be obtained from the specification of the magnet, or an approximate value may be measured simply by putting two magnets next to each other, moving one magnet toward the other and when the other magnet starts to move, the exact distance between the two magnets is measured, the measured distance (mm) is divided by 2 and the result is the magnet field range F).
Md is the magnet diameter (mm).

Using the above formula and the first or the second embodiment specification, the number of the permanent magnets 10 arranged at each side of the anode plates 2 and at neutral plates 3 is calculated as follows:

Anode plate 2 dimensions a: 180 mm×180 mm

Magnet 10 field range F: 7.5 mm

Diameter of magnet 10 Md: 10 mm

$$M n = \frac{180}{( 7.5 \times 2 ) + 10} = 7.2$$

In this case the optimum number of permanent magnets 10 would be 8 pcs.

Preferably, the magnets are arranged in such a way that a substantially homogeneous magnetic field is provided in the region between the plates.

As the permanent magnets 10 are positioned at the anode plates 2 and their north side is always facing the respective cathode plate 1, the magnetic field increases the gas production, wherein the increase may be observed right from the start of the operation of the reactor.

During the electrolysis of water, 2H₂O is separated in 2H₂+O₂.

Considering water (2H₂O), the oxidation state of hydrogen is +1 and the oxidation state of oxygen is −2.

Due to electrolysis, the hydrogen gains electrons, on the other side the oxygen loses 2 electrons and those electrons travel to the anode side. That is why the magnet 10 on the anode side will accelerate these electrons which will leads to acceleration of the production without increasing the supplied power energy. Thus, the electrons are accelerated and the efficiency of the reactor is increased. Various electrolytes may be used, such as water and solutions of water with NaHCO₃ (preferably 10% NaHCO₃ in water), acetic acid, sodium hydroxide, potassium hydroxide, potassium carbonate.

For example, when using a 10% solution of NaHCO₃ in water, the ion with the negative charge in the half reaction is:

2H₂O+2e⁻=H₂+2H0⁻

The magnetic field also has an enormous effect on the sodium bicarbonate and since the sodium bicarbonate is a salt composed of a sodium cation (Na⁺) and a bicarbonate anion (HCO₃−), the permanent magnet 10 provides a force on the Na⁺ and increases its performance and the force may be calculated by using this equation:

F=qvB sin θ

F=force

q=charge on the particle

v=speed (speed of the ions can be obtained from the water pump pressure, length of tubes in/out of the reactor and time)

B=Magnetic field strength (Tesla)

θ=angle between the magnetic field vector and the velocity vector of the charge particle.

At different positions of the magnetic field, the force can be calculated using this equation for the above specified preferred embodiment of the reactor, wherein the calculated force on the Na⁺ will be between 800 N to 820 N, which means that without a doubt the electrolysis process will be very efficient.

For example, sodium ions (Na⁺) move at 0.851 m/s, the magnetic field for all the magnets has a strength of 0.245 T (this factor may be obtained from the magnets' specification or from a magnet measure instrument “Gaussmeter”). This magnetic field has an effect on the ions from different angles as it moves, in our example here we will take 51.0° as an average angle during the motion of the sodium ions. The quantity of the water moving between cells is around 100 cm³ and the concentration of the Na⁺ is 3.00×10²⁰ ions per cm³.

q (for Na⁺)=1.6×10⁻¹⁹ C

v=0.851 m/s

B=0.254 T (Tesla)

θ=51.0°

Thus, the force per 1 ion: F=(1.60×10⁻¹⁹ C)(0.851 m/s)(0.254T))sin(51.0° F.=2.69×10⁻²° N

Number of ions N=(3.00×10²⁰ ions/cm³) (100 cm³) N=3.00×10²² ions

Hence, the total force F=(2.69×10⁻²⁰ N/1 ion)(3.00×10²² ions)

F=807 Newton

Comparative measurements have been made using the above specified first exemplary embodiment of the reactor for the production of oxyhydrogen (with the arranged permanent magnets and without any permanent magnets) with the electrolyte consisting of 10% solution NaHCO₃ in water.

Power consumption with magnets:

DC Voltage: 17 V-18 V

DC Amp.: 18 A-20 A

Produced gas: 8 lit/min

Power consumption without magnets:

DC Voltage: 28 V

DC Amp.: 40 A

Produced gas: 2-3 lit/min

The above measurements show that the production of oxyhydrogen in the reactor with magnets is significantly higher, while the supplied power (voltage, current) for the same is much lower.

The functionality and effectivity of the reactor according to the invention was tested and approved by an authorized institute (Institute of general and physical chemistry, Belgrade, Serbia). Moreover, the reactor was also found environmentally friendly, without producing any waste.

The above specified reactors may have their outlet(s) for gas connected via pipelines to further devices for cleaning and or drying the gas as known in the art.

Although multiple exemplary embodiments are described above, it is obvious that those skilled in the art would easily appreciate further possible alternatives to those embodiments. Hence, the scope of the present invention is not limited to the above exemplary embodiments, but it is rather defined by the appended claims.

1. A reactor for gas production, the reactor comprising:
a set of mutually parallel plates arranged spaced apart from each other, and adapted to be attached to a current source such that at least one of the plates is a cathode plate, at least one of the plates is an anode plate, and at least one of the plates is a neutral plate and arranged between the cathode plate and the anode plate,
a plurality of frames with each of the frames being arranged for circumferentially enclosing a cavity extending adjacent to at least one of the plates,
a conduit for supplying a liquid comprising water and an electrolyte into the cavities and a conduit for leading a liquid enriched with a produced gas formed in the cavities from the reactor, and
at least one permanent magnet attached to the at least one anode plate and to the at least one neutral plates spaced apart from each other at a side of the anode plate that faces the at least one cathode plate, wherein the north sides of the at least one permanent magnet faces the cathode plate.

2. The reactor according to claim 1, wherein the plates and frames are provided with mutually aligned first through holes forming the conduit for supplying the liquid and with mutually aligned second through holes forming the conduit for leading the liquid enriched with the produced gas formed in the cavities, and wherein each frame is provided with a passage connecting the first through holes with the respective cavity enclosed by that frame and a passage connecting the second through holes with the respective cavity enclosed by that frame.

3. The reactor according to claim 1, further comprising:
a plurality of membranes, each membrane being arranged between two adjacent plates and dividing one of the cavities into two sub-cavities, each of the two sub-cavities extending along one of the two adjacent plates, wherein the reactor comprises two individual conduits for leading the liquid enriched with produced gas formed in the cavities from the reactor.

4. The reactor according to claim 2, wherein each frame comprises two parts between which a membrane is fastened, wherein the plates and frames are provided with mutually aligned third through holes forming another conduit for leading the liquid enriched with the produced gas formed in the cavities, wherein each first part of the frames is provided with a passage connecting the second through holes with the a respective sub-cavity enclosed by that first part of the frame and each second part of the frames is provided with a passage connecting the third through holes with the respective sub-cavity enclosed by that second part of the frame.

5. The reactor according to claim 3, wherein each frame comprises two parts, between which the membrane is fastened, wherein the plates and frames are provided with mutually aligned third through holes forming another conduit for leading the liquid enriched with the produced gas formed in the cavities, wherein each first part of the frames is provided with a passage connecting the second through holes with a respective sub-cavity enclosed by that first part of the frame and each second part of the frames is provided with a passage connecting the third through holes with a respective sub-cavity enclosed by that second part of the frame.

6. The reactor according to claim 1, wherein each of the at least one permanent magnets is: (i)
a neodymium magnets; (ii)
of a disc shape having a diameter of from 7 to 13 mm; (iii)
of a thickness of from 0.4 to 1.5 mm; or (iv) any of (i)-(iii).

7. The reactor according to claim 1, wherein the plates are made of stainless steel, and/or at least some of the plates are provided with scratches on a surface thereof.

8. The reactor according to claim 1, wherein the spacing between adjacent plates is uniform and within the range of from 2.3 to 2.9 mm.

9. The reactor according to claim 1, wherein the plates one of the set are arranged in a sequence comprising a cathode plate, a plurality of neutral plates, an anode plate, a plurality of neutral plates, and a cathode plate.

10. The reactor according to claim 9, wherein the number of neutral plates at one side of the anode plate is the same as the number of the neutral plates at the other side of the anode plate, such that the anode plate is arranged in the middle of the set.

11. The reactor according to claim 1, further comprising at least two electrically insulating and water-proof end members, wherein the plates and the frames are clamped between the at least two end members.
